(19) United States
(12) Patent Application Publication
(10) Pub. No.: US 2004/0019863 A1
(43) Pub. Date: Jan. 29, 2004

(54) Circuit verification apparatus, circuit verification program, and circuit verification method

(75) Inventor: Kiyoshi Inoue, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/336,828

(22) Filed: Jan. 6, 2003

(30) Foreign Application Priority Data
Jul. 29, 2002 (JP) 2002-219887

(51) Int. Cl. G06F 17/50

(52) U.S. Cl. 716/5

(57) ABSTRACT

A circuit verification apparatus, a circuit verification program and a circuit verification method are provided in which in the verification of a circuit according to software, the probability that an accumulation circuit such as a queue circuit, etc., changes into a saturated state can be increased without changing the logic of the circuit to be verified, thus making it possible to shorten the time required for the circuit verification. The circuit verification apparatus, which verifies an operation of the circuit to be verified when a queue circuit description operation part (45) is saturated, a verified circuit description part (40) for performing the operation of the circuit to be verified, a test control part (31) for generating an operation control signal to control an operation speed of the verified circuit description part (40), a delay processing part (34) for controlling the operation control signal to change the queue circuit description operation part (45) into a saturated state, and a confirmation signal monitoring part (33) for monitoring a confirmation signal representing that the queue circuit description operation part (45) has been changed into the saturated state in an operation of the verified circuit description section (40).

### BACKGROUND OF THE INVENTION

1. Field of the Invention

The present invention relates to a circuit verification apparatus, a circuit verification program and a circuit verification method for verifying the operation of a circuit designed by software by making the circuit operate as software, and more particularly, it relates to a circuit verification apparatus, a circuit verification program and a circuit verification method for verifying the operation of circuitry including an accumulation circuit when the accumulation circuit has been saturated in the verification of the circuitry.

2. Description of the Related Art

Recently, designing of circuits is performed by the use of software run on a computer. That is, a hardware circuit is described and designed as software, and the verification of the hardware circuit is performed in the state of software. As a result, before the hardware circuit is actually produced, it is able to be confirmed whether the logic of the circuit is correct. Since only the adjustment of the software has to be performed when the circuit is changed, there is an advantage that a circuit verification according to software can be carried out without spending much time and labor.

For instance, a circuit simulation method for simulating a circuit such as an LSI circuit is disclosed in Japanese patent application laid-open No. Hei 8-329121. That is, according to this circuit simulation method, by associating an independently defined lead/lag time with an input condition which is uniquely decided depending on a model in which an input signal is spuriously given to a circuit to be simulated, there is provided a function of automatically varying the generation timing of the input signal which is decided in accordance with the model, the input signal being able to be generated at an arbitrary point in time within a range of the lead/lag time upon each simulation. According to such a technique, in the simulation of a circuit such as an LSI circuit, a pseudo input signal given by a model can be discretely or sequentially varied with time width. As a result, the simulation verification can be brought close to practical circuit verification, thus making it possible to improve its reliability.

Now, reference will be made to a circuit verification apparatus related to the present invention while referring to FIG. 3. As shown in FIG. 3, this circuit verification apparatus 10 includes an input part 11, a storage part 12, an arithmetic processing or calculation part 13 and an output part 14. The storage part 12 stores a circuit verification program that has a circuit verification function as well as a circuit to be verified which is described by software. The input part 11 accepts, from a user, settings or like for the circuit verification function, the circuit to be verified, etc. The calculation part 13 performs a circuit verification by executing a test program on the circuit to be verified, and outputs the results to the output part 14. The output part 14 informs the results of the circuit verification to the user, so that the user can confirm whether the logic of the circuit to be verified is correct.

Next, reference will be made to one example of the configuration of the circuit to be verified by the circuit verification apparatus 10 while referring to FIG. 4. As shown in FIG. 4, the circuit 20 to be verified includes a memory circuit 21, an A circuit 22 and a B circuit 23. The memory circuit 21 is provided with a test program 27 by which the circuit to be verified is operated. The A circuit 22 is a part to be verified whereas the B circuit 23 is a part which is not to be verified. Here, the case where the A circuit 22 includes a data stacking or accumulation circuit in the form of a queue circuit will be described as an example. More specifically, the A circuit 22 comprises a high speed circuit 24, a queue circuit 25 and an ordinary circuit 26.

Hereinbelow, reference will be made to the operation of the conventional circuit verification apparatus 10 in case where the A circuit 22 carries out certain arithmetic calculations. When an acceptance signal is input from the queue circuit 25 to the high speed circuit 24, the high speed circuit 24 acquires the data to be used for the arithmetic calculations from the outside, and outputs it to the queue circuit 25 where the data input from the high speed circuit 24 is stacked. When the data can be stacked by the queue circuit 25, an acceptance signal is output to the high speed circuit 24, whereas when the queue circuit 25 comes to a queue full state and cannot stack the data, the queue circuit 25 generates a queue full signal to the high speed circuit 24. When a completion signal from the ordinary circuit 26 is input to the queue circuit 25, the queue circuit 25 outputs pieces of data in their stacked order to the ordinary circuit 26. When the ordinary circuit 26 performs the arithmetic calculations by using the data input from the queue circuit 25, and outputs a completion signal to the queue circuit 25 when the calculations have been finished.

In the A circuit 22 that performs the above-mentioned operation, when the operation of the high speed circuit 24 is verified in the queue full state of the queue circuit 25 for instance, the probability that the queue circuit 25 changes into the queue full state is extremely limited, thus making it difficult to perform such a verification.

Under this circumstance, in the past, there has been proposed a first method for solving the above problem in which as many conditions as possible under which the queue circuit 25 can change into a queue full state are prepared, and in consideration of a variety of operation timings in the actual hardware circuit, tests of possible combinations between the conditions thus prepared and the operation timings are sequentially carried out by means of the circuit verification apparatus 10 until the queue circuit 25 comes to a queue full state. Alternatively, as a second solution for the above problem, there has also been performed a method of increasing the probability that the queue circuit 25 changes into a queue full state, by changing or modifying the logic of the queue circuit 25 itself. For instance, while the actual queue circuit 25 is a four-stage stack, the probability of the queue circuit changing into a queue full state is increased by modifying the queue circuit into a two-stage stack.

However, the first method has the following problem. That is, it is conceivable that there exist a great number of conditions under which the queue circuit can change into a queue full state, and in addition, when consideration is given to the presence of a variety of operation timings in the actual hardware circuit, there will be an astronomical number of possible combinations between the conditions and the operation timings to be tested. On the other hand, since the probability of the queue circuit changing into a queue full state is extremely limited, the time taken until the queue circuit changes into a queue full state will be very long, or the queue circuit does not necessarily change into a queue full state without fail.

Moreover, in the second method, there arises another problem in that even if the A circuit 22 with the logic of its queue circuit being modified from the four-stage stack into the two-stage stack operates normally, it is uncertain whether the A circuit 22 will operate normally when the logic is returned to the actual queue circuit of the four-stage stack. That is, there is a problem of verifying a circuit of a logic different from the actual one.

A further problem is that upon circuit verification, it is ideal to verify all the possible states that can take place on the hardware, but since the speed of a simulation performed by the circuit verification apparatus through software is about 10⁶ times as slow as the operation speed of the actual hardware circuit, it is necessary to verify the circuit efficiently without performing similar verifications as much as possible. Therefore, all the states could not be verified or time and effort might be needed for some thought or contrivance to perform efficient verifications.

### SUMMARY OF THE INVENTION

The present invention is intended to obviate the above-mentioned problems, and has for its object to provide a circuit verification apparatus, a circuit verification program and a circuit verification method which are capable of increasing the probability that an accumulation circuit such as a queue circuit, etc., changes Into a saturated state without changing the logic of a circuit in the verification thereof according to software, as well as of shortening the time required for the circuit verification.

In order to solve the above-mentioned problems, according to one aspect of the present invention, there is provided a circuit verification apparatus for verifying an operation of a circuit when an accumulation circuit included in the circuit to be verified becomes a saturated state, the apparatus comprising: a verified circuit description operation section in which an operation of the circuit to be verified is described, and which performs the operation of the circuit to be verified; an operation control signal generation section for generating an operation control signal to control an operation speed of the verified circuit description operation section; a signal control section for controlling the operation control signal thereby to change the accumulation circuit into a saturated state; and a confirmation signal monitoring section for monitoring a confirmation signal representing that the accumulation circuit has been changed into the saturated state in an operation of the verified circuit description operation section.

With the above arrangement, by controlling the operation control signal, the probability that the accumulation circuit of the verified circuit description operation section changes into the saturation state can be increased. In addition, by observing the confirmation signal, a determination can be made as to whether the verification of the verified circuit description operation section has been completed. In a preferred embodiment, the verified circuit description operation section is constituted by a verified circuit description operation section 40; the accumulation circuit is constituted by a queue circuit description operation part 45; the operation control signal generation section is constituted by a test control part 31; the signal control section is constituted by a delay processing part 34; and the confirmation signal monitoring section is constituted by a confirmation signal monitoring part 33.

Preferably, the signal control section updates an amount of control of the operation control signal supplied to the circuit to be verified when a confirmation signal is not detected for a prescribed period by the confirmation signal monitoring section. Thus, by updating the amount of operation of the operation control signal when a confirmation signal is not detected for a certain period, the probability that an accumulation circuit portion of the verified circuit description operation section changes into the saturation state can be increased.

Preferably, the signal control section comprises a delay section for controlling the operation control signal supplied to an post-accumulation circuit that utilizes an operation result of the accumulation circuit, thereby to delay an operation of the post-accumulation circuit. Thus, by delaying the operation of a post-accumulation circuit (i.e., a circuit portion downstream of the accumulation circuit) of the verified circuit description operation section, the probability that the accumulation circuit of the verified circuit description operation section changes into the saturation state can be increased. In a preferred embodiment, the post-accumulation circuit is constituted by an ordinary circuit description operation part 46, and the delay section is constituted by the delay processing part 34.

Preferably, the circuit verification apparatus further comprises a storage section for storing a plurality of sets of information on the confirmation signal, information on a signal involved that is a factor generating the confirmation signal, and information on an amount of control to control the signal involved; and a signal setting section for extracting information on the signal involved and the amount of control from the storage section based on information on a confirmation signal indicated by a test program, thereby to set the information thus extracted to the signal control section. The verified circuit description operation section comprises a memory circuit description operation section in which an operation of a memory circuit storing the test program is described, the memory circuit description operation section performing the operation of the memory circuit. With this arrangement, by retrieving the information on the signal involved and the information on the amount of operation from the storage section according to the information on the confirmation signal indicated by the test program, the signal setting section can acquire information on the signal necessary for the circuit verification and information on the amount of operation therefor. In a preferred embodiment, the storage section is constituted by a library file 35, and the signal setting section is constituted by a signal setting part 32.

Preferably, the signal control section recognizes based on the information on the signal involved that an object to be controlled by the operation control signal is the post-accumulation circuit. Thus, the signal control section can control the operation control signal supplied to the post-accumulation circuit that outputs the signal involved. Preferably, the accumulation circuit comprises any of a queue circuit, a buffer circuit, a pipelined circuit and a cash circuit. Thus, the probability that the queue circuit, the buffer circuit, the pipelined circuit, or the cache circuit changes into a saturation state can be increased, thereby making it possible to improve the reliability of the verification.

According to another aspect of the present invention, there is provided a circuit verification program which is stored in a computer readable medium for making a computer verify an operation of a circuit when an accumulation circuit included in the circuit to be verified becomes a saturated state. The circuit verification program is adapted to make the computer perform the steps of: operating the circuit to be verified while generating an operation control signal to control an operation speed of the circuit to be verified in a described operation of the circuit to be verified; controlling the operation control signal to delay an operation of a post-accumulation circuit which utilizes an output of the accumulation circuit; and monitoring a confirmation signal representing that the accumulation circuit has been changed into the saturated state in the described operation of the circuit to be verified. With such a configuration, by controlling the operation control signal, the probability that the accumulation circuit of the verified circuit description operation section changes into the saturation state can be increased. In addition, by monitoring the confirmation signal, a determination can be made as to whether the verification of the verified circuit description operation section has been completed. Here, note that the computer readable medium in the present invention includes portable storage mediums such as a CD-ROM, a flexible disk, a DVD disk, a magneto-optical disk, an IC card, etc., databases holding computer programs, other computers and their databases, and transmission mediums on lines.

According to a further aspect of the present invention, there is provided a circuit verification method for verifying an operation of a circuit when an accumulation circuit included in the circuit to be verified becomes a saturated state. The method comprises the steps of: operating the circuit to be verified while generating an operation control signal to control an operation speed of the circuit to be verified in a described operation of the circuit to be verified; controlling the operation control signal to delay an operation of a post-accumulation circuit which utilizes an output of the accumulation circuit; and monitoring a confirmation signal representing that the accumulation circuit has been changed into the saturated state in the described operation of the circuit to be verified. According to this method, by controlling the operation control signal, the probability that the accumulation circuit of the verified circuit description operation section changes into the saturation state can be increased. Also, by monitoring the confirmation signal, it is possible to determine whether the verification of the verified circuit description operation section has been completed.

The above and other objects, features and advantages of the present invention will become more readily apparent to those skilled in the art from the following detailed description of a preferred embodiment of the present invention taken in conjunction with the accompanying drawings.

### BRIEF DESCRIPTION OF THE DRAWINGS

FIG. 1 is a block diagram showing one example of the configuration of a circuit verification program that is run on a circuit verification apparatus according to the present invention.

FIG. 2 is a flow chart showing one example of the operation of the circuit verification program that creates a queue full state of a circuit to be verified.

FIG. 3 is a block diagram showing one example of the construction of the circuit verification apparatus according to the present invention.

FIG. 4 is a block diagram showing one example of the configuration of a circuit to be verified.

### DESCRIPTION OF THE PREFERRED EMBODIMENT

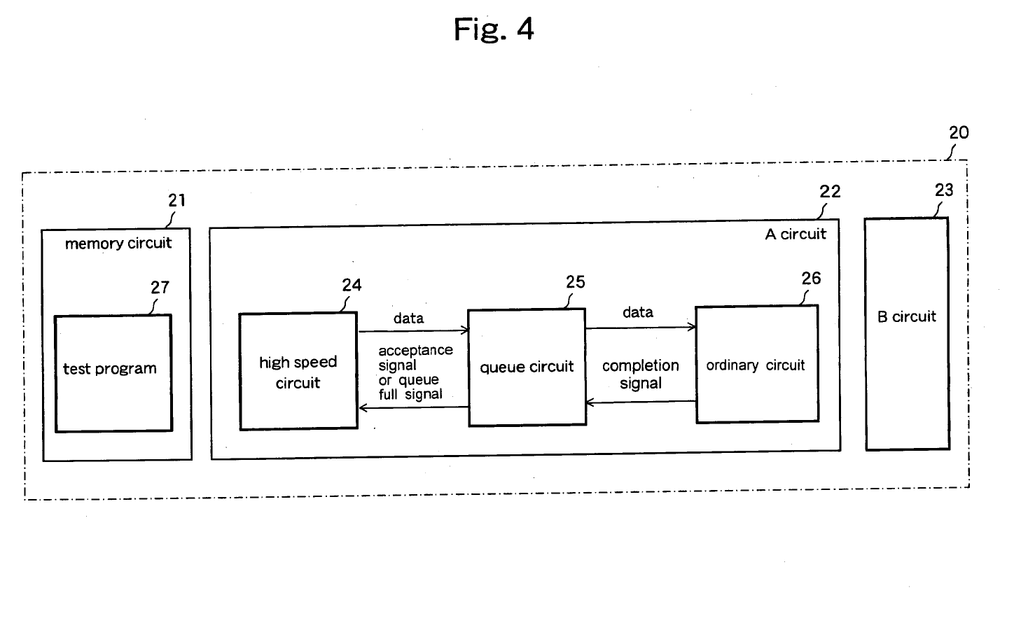

Hereinafter, a preferred embodiment of the present invention will be described in detail while referring to the accompanying drawings. In this embodiment, a mechanism for monitoring the transition or change of a specific state of a usually extremely low probability and a mechanism for intentionally creating the specific state are achieved by using an existing technique without changing the logic of a circuit to be verified. A commercial test bench as well as an assertion checker that is a function of the test bench is utilized as the existing technique. Note that in this embodiment, the following explanation will be made by taking a queue full state as an example of a specific state of the circuit to be verified. Though the same hardware as the circuit verification apparatus 10 shown in FIG. 3 is used in this embodiment, a circuit verification program of the present invention stored in the storage part 12 is different from the one used in the apparatus 10 as described above. In addition, the circuit to be verified in this embodiment is the same as the circuit shown in FIG. 4.

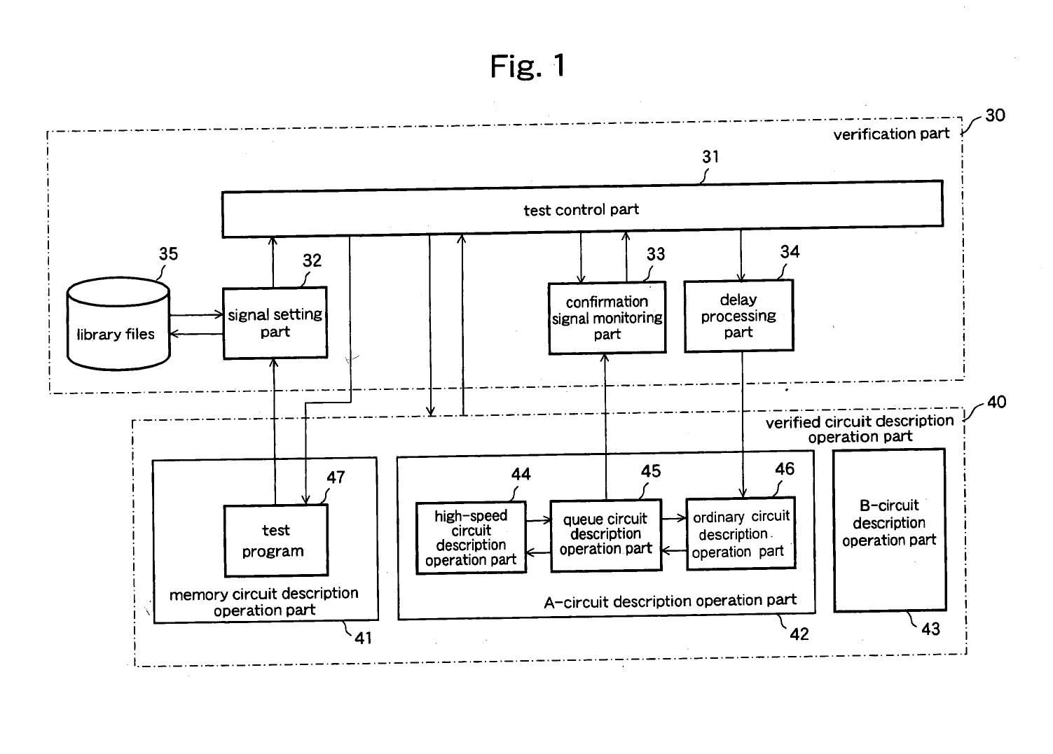

Now, reference will be made to the circuit verification program running on the circuit verification apparatus of the present invention while using FIG. 1. As shown in FIG. 1, this circuit verification program includes a verification part 30 and a verified circuit description operation section 40. The verification part 30 is a functional part for verifying the circuit to be verified, and it includes a test control part 31, a signal setting part 32, a confirmation signal monitoring part 33, a delay processing part 34, and a library file 35. A commercial test bench on the market is utilized as the test control part 31. Also, an assertion checker is used as the signal setting part 32, the confirmation signal monitoring part 33 and the library file 35. The test control part 31 provides an input signal for the verified circuit description operation section 40 and an operation control signal necessary for the operation of the verified circuit description operation section 40, and monitors the output signal of the verified circuit description operation section 40. The operation control signal in this embodiment is a clock.

Moreover, the verified circuit description operation section 40 is a part verified by the verification part 30, and it describes the circuit to be verified shown in FIG. 4 with software. The verified circuit description operation section 40 includes a memory circuit description operation part 41, an A-circuit description operation part 42 and a B-circuit description operation part 43. The memory circuit description operation part 41 is provided with a test program 47 for operating the verified circuit description operation section 40, and the A-circuit description operation part 42 is provided with a high-speed circuit description operation part 44, a queue circuit description operation part 45 and an ordinary circuit description operation part 46.

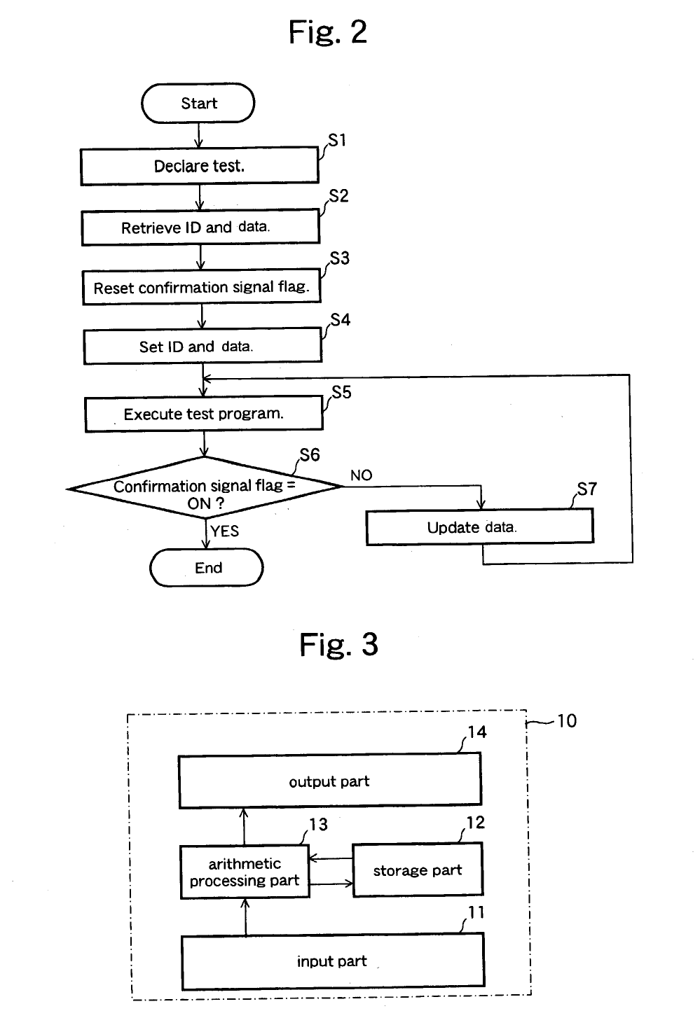

Next, reference will be made to the operation of the circuit verification program by using the flow chart of FIG. 2. Here, as one example, reference will be made to the testing of the operation of the A-circuit description operation part 42 when the queue circuit description operation part 45 changes into a queue full state.

First of all, when the test control part 31 directs starting the test program 47 in the memory circuit description operation part 41, the test program 47 outputs the declaration of a test to the signal setting part 32 (step S1). Upon start of the test program 47, the test control part 31 initializes registers, etc., or performs initial settings for starting the test program 47. Note that the test declaration means a declaration of what test is performed, and includes the identifier of a confirmation signal to be monitored. The confirmation signal is a signal representative of a state transition (a change in the state of the circuit to be verified), and the confirmation signal in this embodiment is a queue full signal which is generated when the queue circuit description operation part 45 becomes a queue full state. Further, the content of the test declaration in this embodiment is the testing of the operation of the A-circuit description operation part 42 when the queue circuit description operation part 45 becomes the queue full state.

Then, the signal setting part 32 receives the test declaration and retrieves an ID and data for the test from the library file 35 based on the identifier of the confirmation signal (step S2). Here, note that the library file 35 is a database storing a plurality of sets of the identifiers of confirmation signals, IDs corresponding to the confirmation signals, and pieces of data corresponding to the respective IDs. An ID is the identifier of each signal involved that becomes a factor to generate a corresponding confirmation signal, and a piece of data is an amount of control by which a corresponding signal involved is controlled. The signal setting part 32 outputs the identifier, the ID and the data of a confirmation signal to the test control part 31. Here, note that a signal involved is a completion signal output from the ordinary circuit description operation part 46 to the queue circuit description operation part 45, and an amount of control is a delay time by which the delay processing part 34 delays the ordinary circuit 26.

Subsequently, the test control part 31 outputs the identifier of the confirmation signal to the confirmation signal monitoring part 33. In order to start monitoring the confirmation signal indicated by the identifier of the confirmation signal, the confirmation signal monitoring part 33 resets a confirmation signal flag (step S3). The confirmation signal flag means a flag indicating the generation of a confirmation signal.

Thereafter, the test control part 31 supplies an operation control signal necessary for the operation of the verified circuit description operation section 40 to the delay processing part 34, and at the same time sets the ID and the data to the delay processing part 34 (step S4). The operation control signal in this embodiment is a clock. The delay processing part 34 delays, by the amount of control indicated by the data, the operation of the ordinary circuit description operation part 46 which outputs a completion signal indicated by the ID. That is, a clock used to operate the verified circuit description operation section 40 is not supplied to the ordinary circuit description operation part 46 in accordance with the amount of control, whereby the operation of the ordinary circuit description operation part 46 is delayed, thus delaying the completion signal accordingly.

Then, the test program 47 is executed (step S5). If the signal output from the queue circuit description operation part 45 to the high-speed circuit description operation part 44 is a confirmation signal, i.e., a queue full signal, the confirmation signal monitoring part 33 turns the confirmation signal flag on and outputs it to the test control part 31.

The test control part 31 makes a determination as to whether the confirmation signal flag is in an “on” state (step S6). If the confirmation signal flag is in an “on” state (YES in step S6), the test program 47 are ended, thus terminating this control flow. If, however, there are other test programs, the next test program is started.

On the other hand, if in step S6 the confirmation signal flag is in an “off” state (NO in step S6), the test control part 31 updates the data (step S7). That is, the amount of control is increased by a prescribed extent so that the delay of the operation of the ordinary circuit description operation part 46 is accordingly increased. Thereafter, a return to the processing in step S5 is performed, and the test program is executed again. Thus, the completion signal is delayed by increasing the delay of the operation of the ordinary circuit description operation part 46 until the queue circuit description operation part 45 becomes the queue full state, as a result of which pieces of data are successively stacked one after another into the queue circuit description operation part 45, thereby creating a queue full state.

In this manner, by performing the above-mentioned processing, the probability of the queue circuit description operation part 45 changing into a queue full state is increased without carrying out a great number of tests according to combinations of the conditions, under which the circuit to be verified changes into a queue full state, and a variety of operation timings. Accordingly, it is possible to realize efficient testing.

Although in this embodiment, description has been made by taking a queue circuit as an example of a data stacking or accumulation circuit, the present invention can also be applied to the case where a buffer circuit, a pipelined circuit, a cache circuit or the like is used in place of the queue circuit. In addition, although in this embodiment, the test control part updates the delay time, a delay time may instead be input to the input part of the circuit verification apparatus. Furthermore, in this embodiment, description has been made of the case where the signal control section acting as a delay section serves to delay the operation control signal, but on the contrary, the operation control signal may be controlled to speed up the processing at a preceding or upstream stage of the data stacking or accumulation circuit.

As described in detail in the foregoing, according to the present invention, there are advantageously provided a circuit verification apparatus, a circuit verification program and a circuit verification method in which in the verification of a circuit according to software, the probability that an accumulation circuit such as a queue circuit, etc., changes into a saturated state can be increased without changing the logic of the circuit to be verified, thus making it possible to shorten the time required for the circuit verification.

While the invention has been described in terms of a preferred embodiment, those skilled in the art will recognize that the invention can be practiced with modifications within the spirit and scope of the appended claims.

What is claimed is:

1. A circuit verification apparatus which verifies an operation of a circuit when an accumulation circuit included in the circuit to be verified becomes a saturated state, said apparatus comprising:
a verified circuit description operation section in which an operation of said circuit to be verified is described, and which performs the operation of said circuit to be verified;
an operation control signal generation section which generates an operation control signal to control an operation speed of said verified circuit description operation section;
a signal control section which controls said operation control signal thereby to change said accumulation circuit into a saturated state; and
a confirmation signal monitoring section which monitors a confirmation signal representing that said accumulation circuit has been changed into said saturated state in an operation of said verified circuit description operation section.

2. The circuit verification apparatus as set forth in claim 1, wherein said signal control section updates an amount of control of said operation control signal supplied to said circuit to be verified when a confirmation signal is not detected for a prescribed period by said confirmation signal monitoring section.

3. The circuit verification apparatus as set forth in claim 1, wherein said signal control section comprises a delay section which controls said operation control signal supplied to a post-accumulation circuit that utilizes an operation result of said accumulation circuit, thereby to delay an operation of said post-accumulation circuit.

4. The circuit verification apparatus as set forth in claim 1, further comprising:
a storage section which stores a plurality of sets of information on said confirmation signal, information on a signal involved that is a factor generating said confirmation signal, and information on an amount of control to control said signal involved; and
a signal setting section which extracts information on said signal involved and said amount of control from said storage section based on information on a confirmation signal indicated by a test program, thereby to set the information thus extracted to said signal control section;
wherein said verified circuit description operation section comprises a memory circuit description operation section in which an operation of a memory circuit storing said test program is described, said memory circuit description operation section performing the operation of said memory circuit.

5. The circuit verification apparatus as set forth in claim 4, wherein said signal control section recognizes based on said information on said signal involved that an object to be controlled by said operation control signal is said post-accumulation circuit.

6. The circuit verification apparatus as set forth in claim 1, wherein said accumulation circuit comprises a queue circuit.

7. The circuit verification apparatus as set forth in claim 1, wherein said accumulation circuit comprises a buffer circuit.

8. The circuit verification apparatus as set forth in claim 1, wherein said accumulation circuit comprises a pipelined circuit.

9. The circuit verification apparatus as set forth in claim 1, wherein said accumulation circuit comprises a cache circuit.

10. A circuit verification program stored in a computer readable medium which makes a computer verify an operation of a circuit when an accumulation circuit included in the circuit to be verified becomes a saturated state,
said circuit verification program adapted to make the computer perform the steps of:
operating said circuit to be verified while generating an operation control signal to control an operation speed of said circuit to be verified in a described operation of said circuit to be verified;
controlling said operation control signal to delay an operation of a post-accumulation circuit which utilizes an output of said accumulation circuit; and
monitoring a confirmation signal representing that said accumulation circuit has been changed into said saturated state in the described operation of said circuit to be verified.

11. A circuit verification method which verifies an operation of a circuit when an accumulation circuit included in the circuit to be verified becomes a saturated state,
said method comprising the steps of:
operating said circuit to be verified while generating an operation control signal to control an operation speed of said circuit to be verified in a described operation of said circuit to be verified;
controlling said operation control signal to delay an operation of a post-accumulation circuit which utilizes an output of said accumulation circuit; and
monitoring a confirmation signal representing that said accumulation circuit has been changed into said saturated state in the described operation of said circuit to be verified.
